(19) United States
(12) Patent Application Publication
(10) Pub. No.: US 2004/0158487 A1
(43) Pub. Date: Aug. 12, 2004

(54) Strategic activity communication and assessment system

(75) Inventors: Keith Norman Miles, Guelph (CA); Lynn Michelle Wiegard, Guelph (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: STREAMLINED MANAGEMENT GROUP INC., Guelph (CA)

(21) Appl. No.: 10/359,723

(22) Filed: Feb. 7, 2003

(51) Int. Cl. G06F 17/60

(52) U.S. Cl. 705/11

(57) ABSTRACT

The present invention relates generally to a system and method for the precise communication of strategic activities to employees and the assessment of employee performance based upon the strategic activities. More specifically, it describes a system and process for clearly defining strategic activities that need to be completed by an individual with a specific job title. These strategic activities are defined as Dimensioned Activity Descriptions (DADs). Each DAD is comprised of four quadrants, each of which indicates the activities required to meet one of four levels of performance. The assessment process is fully automated with both employee and assessors being able to comment on an assessment before it is finalized and stored. Reports are automatically generated, typically monthly and yearly to ensure that assessments are being performed on an ongoing basis.

### FIELD OF THE INVENTION

The present invention relates generally to a system and method for the precise communication of strategic activities to employees and the assessment of employee performance based upon the strategic activities.

### BACKGROUND OF THE INVENTION

Traditional employee assessment systems comprise a set of goals that an employee is expected to achieve, based upon their job description. Quite often, such systems do not communicate in practical terms what activity is expected to support overall business objectives. In addition, such systems do not provide a methodology to hold employees accountable by assessing employee activities with reference to a proposed model of activity.

Other assessment systems incorrectly assume that every important activity is measurable through a transaction or financial outcome. Tremendous time and expense is spent building systems to force transactions, collect transactions and summarize transactions to ensure activity that is not easily measurable still continues. Individuals quickly lose interest as the number of transactions multiply. Still other assessment systems create a multitude of numerical targets to motivate individuals and departments to attain the prescribed targets. While of some value, targets can limit potential improvement for when a target is reached, many individuals are tempted to stop striving.

Finally, other employee assessment systems do not interlock the activities of the various departments and groups. As a result, there is no built in support for business-wide objectives. By focusing departments on their own activities without considering the organization's business objectives, these systems foster only departmental improvements, but can damage an organization's ability to deliver on broader objectives.

The present invention addresses the need for an overall company method to communicate strategic activities and assess employee activities to ensure ongoing compliance by:

a) determining strategic activities that reflect the inter locking functions of departments and groups in support of organization-wide priorities;

b) determining a precise description of strategic activities for specified roles that allows differentiation between employee performance levels; and

c) providing an automated employee assessment system to facilitate timely assessments.

### SUMMARY OF THE INVENTION

The present invention is directed to a method for assessing the performance of an employee, the method comprising the steps of:

a) creating one or more dimensioned activity descriptions for the employee;

b) assessing the employee based upon the one or more dimensioned activity descriptions; and

c) recording the results of step b) in a performance database.

The present invention is also directed to a method of improving the performance of an organization, the method comprising the steps of:

a) identifying strategic priorities for the organization;

b) creating one or more dimensioned activity descriptions to guide an employee in implementing the strategic priorities; and

c) assessing an employee based upon the dimensioned activity descriptions.

The present invention is further directed to a strategic activity communication and message system, the system comprising:

a) a performance system;

b) an external network operatively coupled to the performance system; and

c) a plurality of users connected to the external network.

### BRIEF DESCRIPTION OF THE DRAWINGS

FIG. 1 is a schematic diagram of a system utilizing the present invention;

FIG. 2 is a relationship diagram of the main tables of the performance database;

FIG. 3 is a flowchart illustrating the steps in the set up and ongoing use of the present invention;

FIG. 4 is a flowchart illustrating the assessment process; and

FIG. 5 is a flowchart illustrating the reminder process.

### DETAILED DESCRIPTION OF THE INVENTION

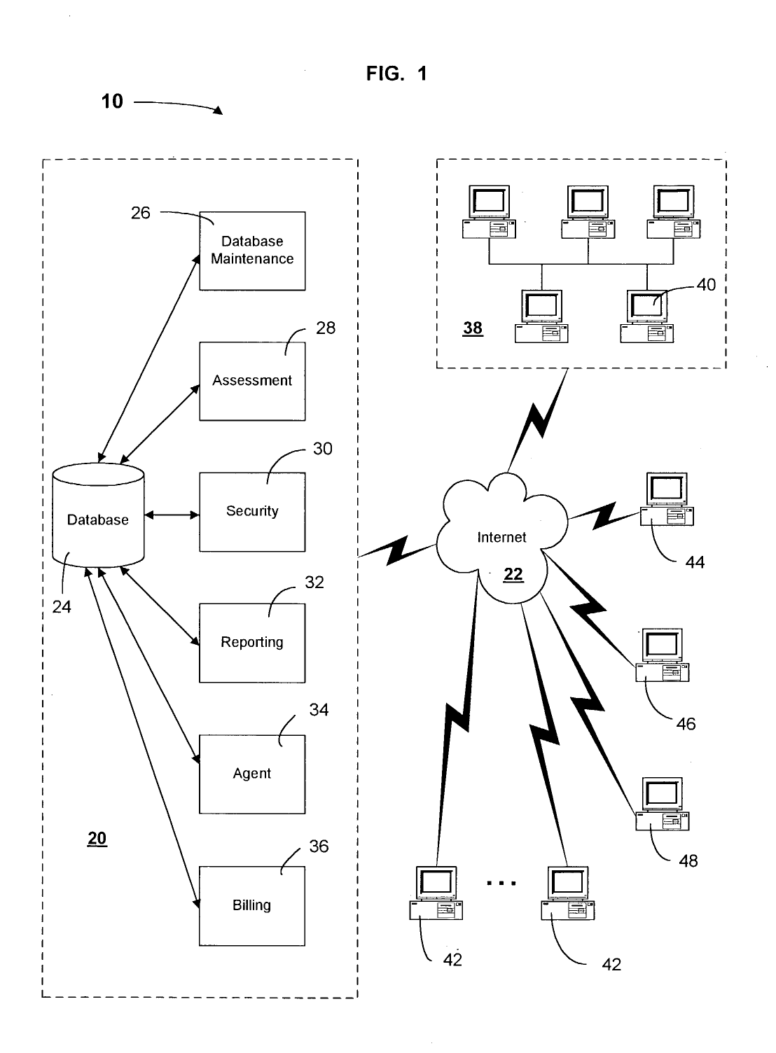

By way of introduction we refer first to FIG. 1. A schematic diagram of a system utilizing the present invention is shown generally as 10. System 10 comprises performance system 20, which is connected to an external network 22 such as the Internet. Performance system 20 is where the present invention resides. Performance system 20 comprises a performance database 24 and a plurality of modules. Module 26 contains the functionality needed to add and update information in database 24. Assessment module 28 contains the functionality needed to create and track the status of assessments for each employee in the database 24. Security logic module 30 provides the functionality required to assign various security levels to individuals accessing the information in database 24. Reporting module 32 accesses information in database 24 to provide status reports as needed. Agent module 34 contains the functionality to support licensed or franchised organizations that may resell or license the use of the present invention. Billing module 36 contains the functionality to generate billing reports for the users of performance system 20. As one skilled in the art can appreciate, performance system 20 may be configured in multiple ways using any number of programming languages. Further, it may reside on multiple machines at different locations. The present example is meant to show a relatively simple configuration. In the preferred embodiment performance system 20 is configured to run on one or more machines connected to the Internet so that users may communicate with performance system 20 using any number of Internet Protocols. As one skilled in the art will also recognize, performance system 20 may reside within a client network and be accessible only from within that network. In the current implementation of the preferred embodiment database 24 is a relational database, in this case Microsoft Access. Performance system 20 is implemented as a web server based application using the ColdFusion tool from Macromedia Inc. As one skilled in the art will appreciate any number of tools may be used to implement the present invention. One such tool would be to make use of encrypted communications between some or all of the components of system 10. By way of example, communication encryption may be implemented through the use of Secure Socket Layers (SSL).

In the example of system 10 two types of user connections are shown, client network 38 and individual clients 42. A client network 38 comprises one or more client nodes 40. Each client node 40 would typically be a desktop or portable computer but may be any device capable of interacting with performance system 20 via client network 38 and network 22. Individual clients 42 connect directly to network 22 to communicate with performance system 20. Each individual client 42 would typically be a desktop or portable computer but may be any device capable of interacting with performance system 20 via network 22.

Administrator 44 is shown connected to performance system 20 via network 22 but may reside on the same computing devices as performance system 20. Administrator 44 serves to allow a system administrator to configure performance system 20. For example, the system administrator for a specific company may enter job titles, address information and other personnel details.

Financial institution 46 is connected to network 22 and allows the clients of performance system 20 to electronically exchange financial information between billing module 36 and a bank or other financial institution regarding the payment of their accounts.

Agent administrator 48 is connected to performance system 20 via network 22. Agent administrator 48 works with agent 34 to permit an organization that sells or licenses the inventions to third parties to configure performance system 20 for their clients, manage data and configure required reporting. For example, the organization may wish to generate billing reports for their clients by adding customized reports to billing module 36.

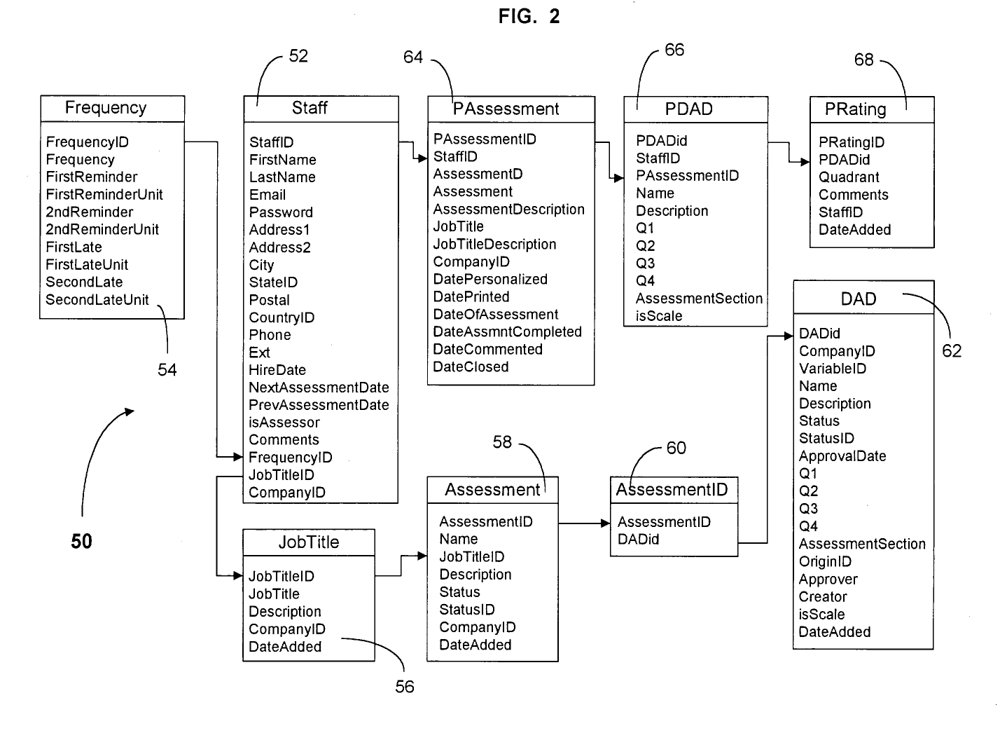

Referring now to FIG. 2, a relationship diagram of the main tables of performance database 24 is shown generally as 50. Database 24 comprises a plurality of tables. FIG. 2 illustrates some of the tables used to record employee assessment information. Later in this disclosure we will discuss in detail how the information in these tables is created and utilized. For now, we provide only a brief overview of the general content of the tables shown in FIG. 2. Staff table 52 contains information about each employee. Frequency table 54 contains information on how frequently an employee is to be assessed based upon their job title. Job title information is stored in JobTitle table 56. Each job title has a corresponding assessment stored in assessment table 58. There may be different assessments for a specific job title, for example there may be draft assessments or assessments that change over time. A specific assessment is identified by AssessmentID table 60. An assessment contains a number of Dimensioned Activity Descriptions (DADs). A DAD describes an activity that an employee is expected to perform. To determine how well the employee performs the activity, a DAD is divided into a number of quadrants. Each quadrant defines a performance level. The DADs and quadrants for a specific assessment are stored in DAD table 62.

PAssessment table 64 contains personalized assessment information for an employee. Many people may conduct a performance assessment for an employee and each of them will have their own entry in table 64. Table 64 becomes populated once an assessment is underway. PDAD table 66 contains information on the DADs for a specific assessment. Finally, PRating table 68 contains the rating for each DAD in the specific assessment, i.e. which quadrant of each DAD matched the performance of the employee.

The tables illustrated in FIG. 2 are meant by the inventors to be examples of how the data utilized in the present invention may be stored. As one skilled in the art will appreciate, many different database configurations may be utilized to work the present invention. Further, the present invention need not be restricted to the use of a relational database, although it is preferred.

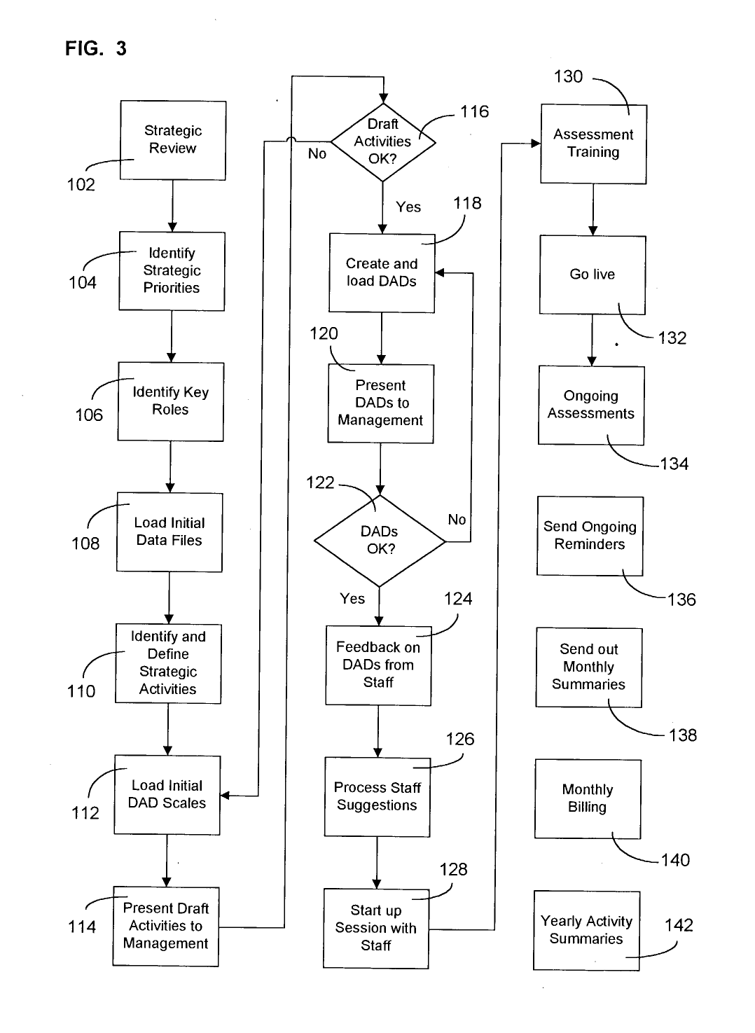

FIG. 3 is a flowchart illustrating the steps in the set up and ongoing use of the present invention. Beginning at step 102 a strategic review is conducted to consider areas such as the market, industry outlook, competition, market distinction, organization, staff skills, strategy and objectives for a certain time period, typically a year. At step 104, strategic priorities are identified based upon the strategic review conducted at step 102. Examples of strategic priorities are: increasing sales, controlling costs or expenses, and distinguishing a product within a market. At step 106 key roles are determined to achieve the strategic priorities, in the example of increasing sales, those in key roles may be the vice-presidents of the company.

Moving on to step 108, the initial data for the company is loaded into database 24. Such information would include job titles and reporting structure. At step 110 the strategic activities required to meet a strategic priority are defined, including activities required to interconnect departments and groups within the organization. For each job title, the strategic activities will vary. For example it may be decided that the vice presidents should meet with a certain number of new referrals a month and provide a monthly report on the status of those meetings. These prospecting activities help the organization meet its strategic priority to increase sales.

At step 112, multiple strategic priorities are mapped onto each job title. Each strategic priority for a job title is examined and a draft DAD is created. The intent at this step is to correctly identify the few activities that support the specific strategic priority the DAD is designed to address and to ensure that activities in surrounding job titles interlock. If done correctly, the entire network of activities supports itself, without requiring specific management attention. While the draft DAD holds the draft activity descriptions, the focus is on getting the right activities listed. The subtle differences in activities that would characterize different levels of employee performance, is not the focus of this step.

A DAD describes related activities that support the strategic priority in a specific job title, using, in general, four graduated descriptions of related activities. In the preferred embodiment each DAD displays the graduated (hence the term Dimensioned) activity descriptions using four quadrants, namely:

1) Immediate Improvement Required

2) Needs Improvement

3) Expected Activity

4) Exceeds Expectations

It is not the intent of the inventor to limit the present invention to the use of four quadrants or to these specific heading descriptions, it is simply the number of graduated descriptions and the initial text headings selected by the inventor for standard usage. Each quadrant within a DAD describes the same related activities in a slightly different way to represent graduating staff performance. A quadrant within a DAD typically contains one to three activities.

At step 114, the list of draft activities is presented to management and information related to levels of employee performance is obtained. Processing then moves to step 116. If the draft activities need to be refined processing returns to step 112, otherwise processing moves to step 118.

At step 118 Dimensioned Activity Descriptions (DADs) are refined and loaded into database 24. At this step descriptions are created to describe the graduation in employee performance so that the differences between the activities described in the quadrants will be distinguishable, observable, and attainable for employees. For example, referring to the strategic activity of prospecting for new sales, the corresponding DAD for a vice-president may be divided into four quadrants, each quadrant typically containing one to three activities related to supporting the strategic activity. An example DAD for such a strategic activity follows:

1) Immediate Improvement Required.

Meets one source of referrals each month and presents a brief verbal summary for each meeting during monthly marketing meeting. Meets with one existing customer every other month and reports verbally during monthly marketing meeting on potential opportunities uncovered. Attends no industry evening social functions.

2) Needs Improvement

Meets three sources of referrals each month and presents a brief verbal summary for each meeting during monthly marketing meeting. Meets with one existing customer a month and reports verbally during monthly marketing meeting on potential opportunities uncovered. Attends one industry evening social function every other month.

3) Expected Activity

Meets five sources of referrals each month and presents brief verbal summary for each meeting during the monthly marketing meeting. Meets with two existing customers a month and reports verbally during the monthly marketing meeting on potential opportunities uncovered. Attends one social function each month.

4) Exceeds Expectations

Meets seven sources of referrals each month and presents a brief verbal summary for each meeting during the monthly marketing meeting. Meets with three existing customers a month and reports verbally during the monthly marketing meeting on potential opportunities uncovered. Attends one industry evening social function each month and participates in committee work.

Thus, a DAD is clear and precise in its communication of what is expected. In the above example, by using observation alone, a senior vice-president can monitor whether the vice-presidents are performing their expected activities by showing up at the monthly marketing meetings and listening to the verbal reports given by the vice-presidents.

Since each assessment, which may contain multiple DADs corresponds to a specific job title, further distinction may be required between two or more individuals who may share the same job title. To accommodate any unique strategic projects or objectives assigned to specific individuals, there also exists an individual section to describe specific projects or objectives that should be completed during the assessment period.

At step 120 the completed DAD's are reviewed with management. A test is then made at step 122 to determine if the DAD's are acceptable, if so the process moves to step 124, if not, the process returns to step 118.

At step 124 the DAD's are reviewed by each employee to which they apply, and an explanation of how they apply to the strategic priorities is provided. Employee comments are collated and reviewed. At step 126 any required changes to the DAD's are applied. At step 128 meetings are held with staff employees to describe how an assessment is conducted. At step 130, training is initiated for the employees who will be assessing others. At step 132 the system is initiated and regular usage begins.

It is not the intent of the inventor to restrict the present invention to the steps of the flowchart of FIG. 3. As one skilled in the art will recognize, some steps may be combined or deleted if required.

Steps 134, 136, 138, 140 and 142 are ongoing functions that will be individually discussed in detail.

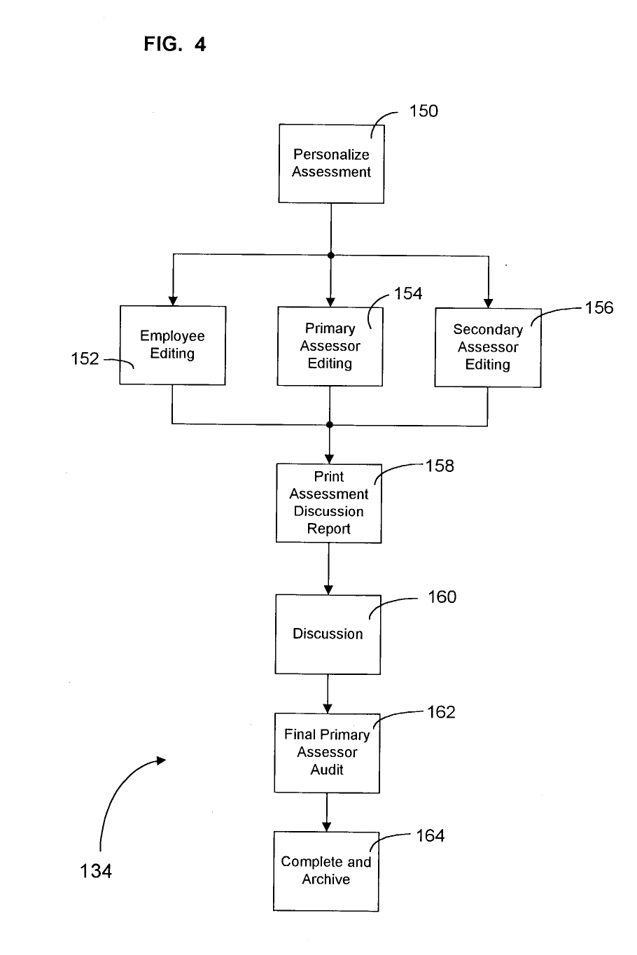

Referring now to FIG. 4, a flowchart illustrating the assessment process is shown generally as 134. This is step 134 of FIG. 3. Beginning at step 150 an assessment is personalized. This is done by taking an assessment for a specific job title from table 58 of FIG. 2 and placing it in table 64. There may be many people with the same job title, so a copy of the assessment is taken. This allows the employee and each person performing an assessment of the employee to edit the assessment independently. At step 152 the employee edits the assessment, indicating which activity descriptions best reflect their activities and adds comments. At step 154 the primary assessor, the individual responsible for ensuring the assessment occurs, edits the assessment, indicating which activity descriptions best reflect the employee's activities and adds comments. At step 156 any secondary assessors, individuals providing input to the assessment but not responsible for ensuring the completion of the assessment, edit the assessment indicating which activity descriptions best reflect the employee's activities and add comments. At step 158 the primary assessor prints the assessment discussion report showing DADs, the ratings of the employee and all assessors, and all comments. At step 160 the employee and the primary assessor (and other assessors as required) discuss the assessment. The primary assessor indicates to the system that the discussion has occurred.

At step 162 the primary assessor can edit the assessment and change ratings and/or add final comments based on the discussion with the employee. At step 164 the primary assessor indicates to the system that the assessment is complete and ready to be archived. The system then records the assessment as complete and archives the completed assessment as a read-only format in tables 64, 66 and 68 of FIG. 2.

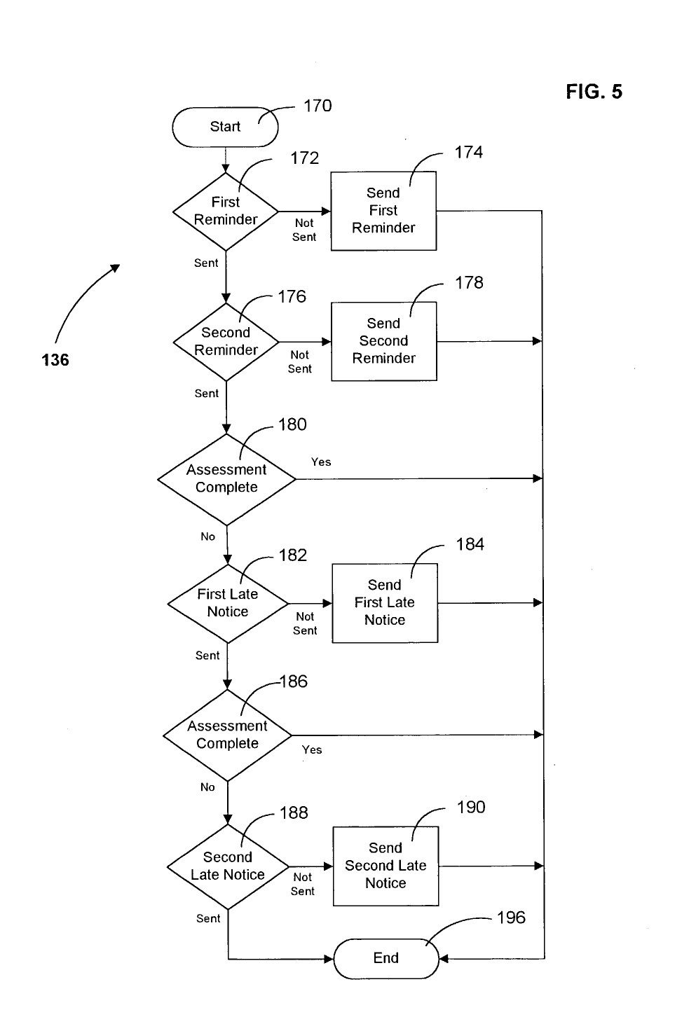

Referring now to FIG. 5, a flowchart illustrating the reminder process is shown generally as 136. This is step 136 of FIG. 3. The reminder process, may be run at any regular interval or initiated at any time. Typically reminders would be sent out on a daily basis. Reminders are sent to the assessors and the employees being assessed, to inform and keep the assessments completed on schedule. Frequency Table 54 (see FIG. 2) contains different profiles that define how often an assessment should occur and when reminders and late notices should be sent. Reminder dates are dynamically calculated using information from Frequency Table 54. The Frequency field of table 54 refers to how often an assessment is to be conducted. Some Frequency profiles define yearly assessments, while those with bi-annual or more frequent assessment frequencies are designed to address employees with performance problems. The frequency profile used by each employee is defined in the Staff Table 52.

The FirstReminder, 2ndReminder, FirstLate and SecondLate fields of table 52 are integer values. The corresponding FirstReminderUnit, 2ndReminderUnit, FirstLateUnit and SecondLateUnit contain unit of measure information, for example days, weeks or months. Together they define when a reminder or late notice should be issued. For example, should a user want first reminders to be issued one month before and assessment is due, then the value of FirstReminder would be set to “1” and the value of FirstReminderUnit would be set to “m” for month. The date for an employee assessment is contained in the NextAssessmentDate field of staff table 52.

Referring back to FIG. 5, the reminder process begins at step 170. At step 172 a test is made to determine if a first reminder needs to be sent. If an assessment has not been completed a first reminder is sent to the appropriate employee and the assessor(s) at step 174. This is typically an early warning of an upcoming assessment and may be set as desired, a typical time frame would be 30 days. Processing then ends at step 196. If a first reminder has previously been sent, processing moves to step 176.

At step 176 a test is made to see if a second reminder needs to be issued. If a second reminder has not been issued, processing moves to step 178, where a second reminder is issued. This would typically occur at 10 days before an assessment is due. At step 178 the assessment is personalized, as discussed earlier (see FIG. 4, step 150) and an entry is created in PAssessment table 64 (see FIG. 2). This occurs automatically at step 178, but may be done at any time prior to the issuance of a second reminder by the primary assessor. Processing then ends at step 196.

If a second reminder has been sent, processing moves to step 180 where a test is made to determine if the assessment has already been completed. If the assessment is complete then processing ends at step 196. If the assessment has not been completed, processing moves to step 182 where a test is made to determine if a first late notice should be generated. If an assessment is late, a first late notice email is sent at step 184, and processing ends at step 196. The recipients of the email generated at step 184 are normally those involved in the specific assessment.

If at step 182 it is determined that a first late notice has been sent, processing moves to step 186. At step 186 a test is made to determine if the assessment has already been completed. If the assessment is complete then processing ends at step 196. If the assessment is not complete, processing moves to step 188.

At step 188 a test is made to determine if a second late notice should be generated. If so, processing moves to step 190 where the second and final late notice is sent to those involved in the assessment and then processing ends at step 196. If at step 188 it is determined that a second late notice was previously sent, processing ends at step 196.

In the above description of the reminder process, the inventor wishes to make it clear that reminder processing may be run at any time, and that reminders are issued for each and every outstanding assessment. As described earlier, there may be more than one assessor for an employee and thus more than one assessment to be completed. As one skilled in the art will recognize, the steps in the reminder process may be altered without affecting the scope of the invention. For example, the test for a completed assessment (steps 180 and 186) may be combined into a single step inserted between steps 170 and 172. In this manner, no further processing would be required for a completed assessment.

We now return to monthly summaries 138 of FIG. 3. In the preferred embodiment, monthly summary reports are sent to senior managers, administration staff and outside funding organizations, such as venture capitalists or banks. The list of recipients and format of the report may be configured to best meet the needs of the client. Typical information in a monthly summary may include:

a) A list of the email activity for the month, for example:

i) number of first reminders sent;

ii) number of second reminders sent;

iii) number of first late notices sent; and

iv) number of second late notices sent.

b) A detailed list of completed assessments along with a numerical value that represents the final rating for a completed specific assessment. This may be arrived at in a number of ways, the most simple being assigning the numbers 1 to 4 to each of the four quadrants of a DAD, where 4 is the highest rating. Each DAD is assigned the number of the quadrant, the numbers for all DADs in an assessment are totalled and divided by the number of DADs in the assessment. The result provides an overall assessment number between 1 and 4.

c) The average days late or early for the completed assessments.

d) A list of incomplete assessments, also with an indication of when they were scheduled for and an average late date.

e) A list of assessments scheduled for the upcoming month.

The month end report summary has four main purposes. Firstly it justifies a licensing or subscription fee by demonstrating that, behind the scenes, the system is completing the administrative functions, thus saving administrative time and serving to justify the fee. Secondly, it provides visibility and accountability to the assessment process. It provides a picture of how well the organization is managing the strategy assessment process. If the organization has areas that are behind in completing scheduled assessments, then the motivation that shapes daily employee decisions is not being applied. If allowed to continue, the organization's lack of discipline will affect the potential benefit of utilizing the system. By highlighting the assessors to senior managers, administrators, and possibly financial institutions, then management can easily see the non-conforming area(s) and correct the situation quickly. Thirdly, it provides information for outside financial partners. If outside firms are providing direct and line of credit funding support, there is an accountability to maintain agreed to levels of financial performance. Financial institutions are looking for additional means to ensure that an organization is driving the strategic activities that will create the expected financial results. By reviewing the monthly summary, these institutions can see whether strategic activity is being encouraged through a disciplined assessment process. Previously, financial organizations had to wait until an accounting period completed and the financial results tabulated in order to gauge the organization's progress. The monthly reports provide a level of inter-period information that has never been available before. If the system is operating well, then the strategic activities specified by the system are happening. In this way, the present invention can act to greatly reduce the risk of bad investments. Fourthly, it provides output to incentive calculation by providing ranked results by employee and job title. By utilizing the output from the system to drive an incentive calculation, employee motivation to attain at least the expected level of activity is intense and ongoing.

We will next discuss the monthly billings feature 140 of FIG. 3. The monthly billing process can be a triggered to generate an invoice to a client or initiate a monthly credit card run. If an invoice is created and sent, the normal accounting process follows it through payment.. If a client agrees to ongoing credit card billing then a Secure Socket Layer (SSL) or other secure means of transmission is utilized to present a credit card information page to a client. The client would then fill in the required credit information and indicate permission to bill the monthly subscription fee using the specified credit card. If the credit card option is selected, the system connects to a financial institution for the billing run once per month. The advantages in doing so are:

a) Less accounts-receivable work to conduct,

b) Lower receivable days; and

c) Consistent cash flow.

We now move to the yearly activity summary feature 142 of FIG. 3. Yearly activity summary reports may be sent to:

a) Senior managers;

b) Administrators, and

c) Outside funding organizations, such as commercial capital, venture capital, or banks.

Similar to the monthly summary reports, the yearly activity summary report provides information summarized for the entire year, for example:

a) Email reminders sent during the year.

b) Listing of the assessments completed during the year with ranking for incentive calculation if used.

c) Average performance of assessment activity for the entire organization (e.g. completed assessments averaged 3 days late).

d) Average performance of assessment activity (days late/early) for each assessor.

e) Average ranking for the organization, using a score of 1 for first quadrant, 2 for second, 3 for third, and 4 for fourth. For most organizations, the objective is to be around 3 for most assessments or the ‘normal’ expected activity.

The yearly activity summary report serves four purposes. Firstly, it justifies the subscription or licensing fee by demonstrating that the automated system is completing administrative functions and saving administrative time. Secondly it provides information and accountability to the assessment process. It provides a picture of how well the organization is managing the strategy assessment process. It also describes the assessment performance for each assessor, typically in days, early or late. By highlighting performance information, management can easily see the non-conforming area(s) and correct the situation. Thirdly, it provides information for outside financial partners. If outside firms are providing direct and line of credit funding support, there is an accountability to maintain agreed to levels of financial performance. Financial institutions can review the summary and evaluate whether or not the organization is driving strategic activity to the degree expected. Fourthly, it provides output to incentive calculations. The system can provide ranked results for inclusion in an incentive calculation. The summarized ranking by individual can be used to drive an incentive calculation, serving to motivate employees to attain higher quadrants within a DAD.

As can be seen from the above description, the present invention differs significantly from traditional performance evaluation systems. A traditional “job description” provides a vague description of a wide spectrum of activities. It provides no real sense of the value of a few strategic activities. Since such descriptions lack precision, they cannot be used to communicate the level of expected performance or differentiate between individuals. The present invention with the use of Dimensioned Activity Descriptions solves these problems. The present invention provides precise, scaled observable descriptions of activities directed to a specific priority. The use of quadrants to define expected activities allows for the clear communication of expected performance, as well as differentiating the level of individual performance within a job title. As there are typically a small number of DADs used in an assessment, and the outcome has an impact on any potential raise, promotion or bonus, there is sufficient clarity and motivation to prompt individuals to conform to the DADs. Finally, the present invention creates an automated accountability system around which the periodic assessment of individual activities will be performed, providing ongoing motivation to staff to conform to the described model of activity.

In summary, the activities described in the quadrants are:

a) Distinguishable, in that different levels of activity between quadrants makes the determination of employee activity more objective and less subjective;

b) Observable, in that the activities described can be easily recognized by an assessor without requiring additional work;

c) Attainable, in that the activities described represent a realistic expectation;

d) Mapable, in that the activities described represent a mapping of a specific business objective into a job title; and

e) Interlocking, in that the activities described link to other organizational levels to support the business objectives of the organization.

The present invention further provides a great deal of flexibility should a change in business strategy occur. It simply requires the redrafting of the required DADs and the changes can be made across the organization within a few days as opposed to the months required by typical performance management systems.

Although the present invention has been described as being a software based invention, it is the intent of the inventor to include computer readable forms of the invention. Computer readable forms meaning any stored format that may be read by a computing device.

Although the invention has been described with reference to certain specific embodiments, various modifications thereof will be apparent to those skilled in the art without departing from the spirit and scope of the invention as outlined in the claims appended hereto.

We claim:

1. A method for assessing the performance of an employee, said method comprising the steps of:
a) creating one or more dimensioned activity descriptions for said employee;
b) assessing said employee based upon said one or more dimensioned activity descriptions; and
c) recording the results of step b) in a performance database.

2. The method of claim 1 wherein step b) allows said employee and one or more assessors to record comments during said assessing.

3. The method of claim 1, wherein each of said dimension activity descriptions comprises a plurality of quadrants.

4. The method of claim 1 further comprising a reminding step, to remind said employee and assessors of said employee of the due dates for an assessment.

5. The method of claim 4 wherein said reminder step comprises the steps of:
a) determining if a first reminder need be sent;
b) determining if a second reminder need be sent;
c) determining if a first late notice should be sent; and
d) determining if a second late notice should be sent.

6. The method of claim 1 further comprising a monthly summaries step, said monthly summaries step generating monthly summary reports.

7. A method of improving the performance of an organization, said method comprising the steps of:
a) identifying strategic priorities for the organization;
b) creating one or more dimensioned activity descriptions to guide an employee in implementing said strategic priorities; and
c) assessing an employee based upon said dimensioned activity descriptions.

8. The method of claim 7, wherein each of said dimension activity descriptions comprises a plurality of quadrants.

9. The method of claim 8 wherein step c) allows said employee and one or more assessors to record comments during said assessing.

10. The method of claim 7 wherein each of said quadrants is assigned a numerical value, the value assigned to each of said quadrants being utilized after completion of step b) to generate an overall assessment value for said employee.

11. The method of claim 7 further comprising the step of identifying key roles to implement said strategic priorities within said organization.

12. A strategic activity communication and message system, said system comprising:
a) a performance system;
b) an external network operatively coupled to said performance system; and
c) a plurality of users connected to said external network.

13. The system of claim 12 wherein said performance system comprises a performance database, said performance database operatively connected to an assessment module.

14. The system of claim 13 wherein said assessment module comprises:
a) means for assessing an employee based upon one or more dimensioned activity descriptions; and
b) means for recording the results of step a) in said performance database.

15. The system of claim 14 further comprising means for recording comments from assessors and said employee during step a).
